(19) United States
(12) Patent Application Publication
(10) Pub. No.: US 2024/0399279 A1
(43) Pub. Date: Dec. 5, 2024

(54) METHODS AND SYSTEMS FOR REDUCING CONTAMINANTS IN A FEED STREAM

(71) Applicant: MARATHON PETROLEUM COMPANY LP, Findlay, OH (US)

(72) Inventors: Nhien Duong, Findlay, OH (US); Montri Vichailak, Findlay, OH (US)

(21) Appl. No.: 18/377,882

(22) Filed: Oct. 9, 2023

Related U.S. Application Data
(60) Provisional application No. 63/470,739, filed on Jun. 2, 2023.

(51) Int. Cl. B01D 46/00; B01D 19/00; B01D 46/44; B01D 46/62; B01D 46/66

(52) U.S. Cl. CPC B01D 46/0027; B01D 19/0063; B01D 46/446; B01D 46/62; B01D 46/66; B01D 2275/30; C10G 31/09; C10G 55/08

(57) ABSTRACT

Systems and methods for methods and systems for reducing contaminants in a feed stream are disclosed. Prior to reaching or upstream from one or more compressors, solid foulant is filtered from a feed stream. The compressor may further filter the feed stream. By reducing the solid foulant entering the one or more compressors, performance and life span of the one or more compressors also can be increased.

### PRIORITY CLAIM

This application claims priority to and the benefit of U.S. Provisional Application No. 63/470,739, filed Jun. 2, 2023, titled “METHODS AND SYSTEMS FOR REDUCING CONTAMINANTS IN A FEED STREAM,” the disclosure of which is incorporated herein.

### FIELD OF THE DISCLOSURE

This disclosure relates to refinery systems and methods for foulant removal from fluid streams. One or more embodiments of such systems and methods may enhance compressor run length in a refinery.

### BACKGROUND

In the petroleum industry, hydrocarbon refining is the conversion of hydrocarbons into various usable hydrocarbon based products. In the manufacturing of these hydrocarbon based products, a series of processing steps are utilized to transform the hydrocarbons into the desired hydrocarbon based products. Often, one or more of these processing steps involves separating the hydrocarbon into liquid and gaseous components. Once separated, the liquid and gaseous components are then processed to remove impurities and convert the liquid and gaseous components into the desired hydrocarbon based products. These impurities may include physical foulants, such as solids, particulates, or semi-solids, that were originally in the hydrocarbons, along with those that form along the refining processing steps. These impurities or contaminants may be referred to as “foulants,” and these foulants may lead to damage in processing equipment or machinery, delays in processing, and altered flow distribution of the product streams.

### SUMMARY

Applicant has recognized that processing equipment or machinery such as compressors particularly are vulnerable to fouling issues, and Applicant's disclosure provides embodiments of methods, systems, and controls for filtering foulant involving compressors. In addition, Applicant has recognized that when fluid streams are filtered for foulant (a) prior to reaching or (b) upstream of a compressor, the life-span of the compressor and efficiency of the refinery process may be extended. Further, Applicant has recognized that removing the foulants, or “fouling” of the product streams in refineries may result in significant financial and environmental problems.

Applicant has recognized the problems noted above herein, and the present disclosure is directed to embodiments of methods and systems of reducing the level of foulant in fluid streams prior to reaching a compressor, thereby to increase the life-span of the compressor and the efficiency of the refinery process, for example.

The present disclosure includes embodiments of methods and systems of reducing contaminants in a fluid stream, for example. The contaminants may include one or more type of foulant, as will be understood by those skilled in the art, such as particulate, solids, or corrosive fouling, or combinations thereof. Foulants may include, for example, leftover liquid hydrocarbons which, when deposited on a compressor's blades, leaves a film that attracts particulates (thus, causing buildup), salt from the air or environment surrounding the compressor, dust and/or sand from the environment, and/or other particulates that may be included within the fluid stream. The fluid stream may include one or more products of a refining process, such as various transportation fuels, for example, gasoline, diesel, jet fuel, renewable transportation fuel, butane, propane, other paraffinic and/or olefinic C1-C4 and C5-C6 hydrocarbons, nitrogen, and/or hydrogen, among others. Further, the fluid stream may include an amount of foulants. In an embodiment, a fluid feed stream including foulants may be supplied to a liquid-gas separator, such as a Knockout drum, as will be understood by those skilled in the art, for example. The fluid feed stream may be considered or include the fluid stream provided to a liquid-gas separator. In an embodiment, the fluid feed stream passes though the Knockout drum, and the fluid feed stream is separated into a liquid stream and a gas stream. The gas stream is filtered within the Knockout drum by way of a filtering system, which may include one or more filters, such as a reticulated particle trap, for example. The reticulated particle trap may include one or more of a reticulated macro-porous particle trap, a reticulated micro-porous particle trap, or a reticulated particle trap comprised of a selected material, the selected material ceramic comprising one of a ceramic, plastic (such as polyether, polyurethane, or other plastic material), metal, or other inert materials. In an embodiment, the gas stream exiting the Knockout drum, or outlet stream, may continue along the refinery process, such as to a compressor, for example. The compressor also may include an additional filter to further remove unwanted products of the refining process.

In another embodiment, various properties of the Knockout drum may be monitored for maintenance needs. The properties may include temperature and pressure, for example. Changes of these properties may be indicative of foulant build up within the filtering system, as will be understood by those skilled in the art. In an embodiment, if the properties indicate that maintenance is needed on a first filtering Knockout drum, the fluid feed stream may be redirected to a second filtering Knockout drum of the system. As the fluid feed stream continues to be filtered by the second filtering Knockout drum, maintenance may be performed on the first filtering Knockout drum.

In another embodiment, a filtered gas stream expelled from a filtering Knockout drum may continue downstream to a compressor. The compressor may include a filtering system that filters remaining foulants from the filtered gas stream. The performance and life span of the compressor may be increased due to the upstream filtering and reduced foulant buildup.

### BRIEF DESCRIPTION OF THE DRAWINGS

These and other features, aspects, and advantages of the disclosure will become better understood with regard to the following descriptions, claims, and accompanying drawings. It is to be noted, however, that the drawings illustrate only several embodiments of the disclosure, which are not necessarily drawn to scale, and, therefore, are not to be considered limiting of the disclosure's scope.

FIG. 1 is a simplified schematic diagram of a filtering system, according to an embodiment of the disclosure.

FIG. 2 is another simplified schematic diagram of a filtering system, according to and embodiment of the disclosure.

FIG. 3 is another simplified schematic diagram of a filtering system, according to an embodiment of the disclosure.

FIG. 4A, FIG. 4B, FIG. 4C, FIG. 4D, FIG. 4E, and FIG. 4F are schematic diagrams of types of filters and knockout drums with varying amounts of filters, according to an embodiment of the disclosure.

FIG. 5 is another simplified schematic diagram of a filtering system, according to an embodiment of the disclosure.

FIG. 6 is a simplified diagram illustrating a control system for filtering foulants, according to an embodiment of the disclosure.

FIG. 7 is a flowchart depicting an overview of an embodiment of the disclosure.

FIG. 8 is a flowchart depicting an overview of an embodiment of the disclosure.

### DETAILED DESCRIPTION

So that the manner in which the features and advantages of the embodiments of the systems and methods disclosed herein, as well as others, which will become apparent, may be understood in more detail, a more particular description of embodiments of systems and methods briefly summarized above may be had by reference to the following detailed description of embodiments thereof, in which one or more are further illustrated in the appended drawings, which form a part of this specification. However, it is to be noted that the drawings illustrate only various embodiments of the systems and methods disclosed herein and are therefore not to be considered limiting of the scope of the systems and methods disclosed herein as it may include other effective embodiments as well.

Refinery systems (for example, a transportation fuel refinery) often exhibit fouling. For example, such fouling includes buildup of foulant in compressors and pumps over a relatively slow amount of time and results in reduced throughput, increased energy consumption, and more frequent shutdowns. Managing foulant build up usually requires pausing or stopping refinery processes to clean equipment or machinery. Further, if cleaning does not occur, the foulant can result in damage to equipment or machinery. These continuous disruptions result in significant financial, environmental, and other problems.

Generally, a compressor, for example, can include a set of mechanical filters in parallel that collect foulant and prevent it from exiting the compressor. As foulant collects in the compressor filter, maintenance or replacement of the filter may be indicated when the pressure differential of the compressor reaches a set or selected limit (for example, as indicated by one or more pressure sensors positioned throughout the compressor and/or at the outlet of the compressor). If foulant build-up within the filter is uneven and alters the flow of the fluid stream, however, the pressure differential may not be reliable to indicate maintenance. For example, Applicant has recognized that this uneven buildup of solids can lead to a high foulant deposition locally in the filter housing while the pressure differential is still below the set limit. Applicant also has recognized this impact on flow distribution. Further, such a foulant deposition may cause valve leakage in the compressor.

In the present disclosure, embodiments of methods and systems are disclosed that can extend the lifespan of a compressor by intercepting potentially damaging foulants prior to reaching the compressor, without disrupting the overall flow of fluid. Specifically, a method is provided to intercept foulants from a fluid feed stream through a filtering system upstream of a compressor, and a system is provided for uninterrupted refinery processing, even in the presence of foulant build up. The method and system disclosed herein have been found to extend the life span of a compressor. For example, a compressor may be run for about 2 years to about 3 years prior to cleaning, whereas, without such a filtering system, the compressor may be cleaned within weeks of operation to about a half a year. Furthermore, the filtering system provides increased filtering capabilities without substantially interrupting or changing the flow rate of the fluid to the compressor. Such systems may utilize components not utilized for filtering, such as a knockout drum, which is designed to remove liquid from a fluid stream, as liquid may damage a compressor. Thus, removal of the foulants using such systems does not include adding additional and expensive equipment, but rather utilizing existing equipment for an additional and/or different purpose. The fluid stream may include a hydrocarbon based fluid stream. The hydrocarbon based fluid stream may include one or more of, for example, gasoline, diesel, jet fuel, renewable transportation fuel, butane, propane, other paraffinic and/or olefinic C1-C4 and C5-C6 hydrocarbons, nitrogen, and/or hydrogen, among other types of hydrocarbons.

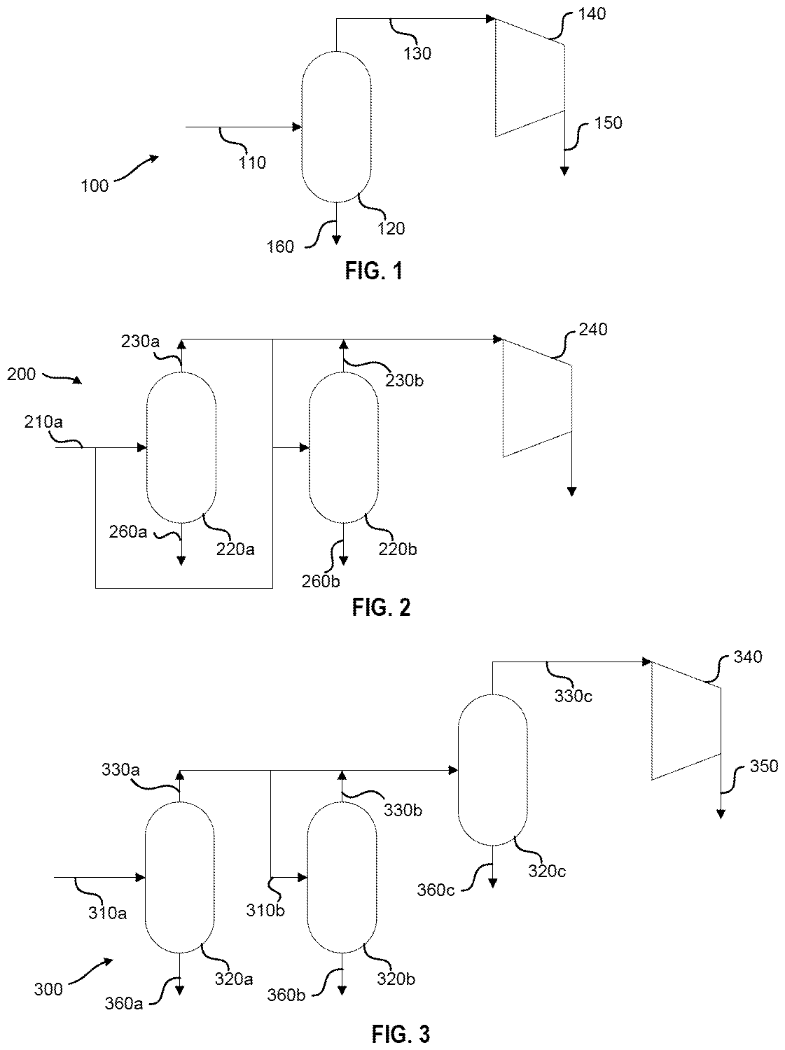

FIG. 1 shows a schematic method flow diagram 100, according to an embodiment of the present disclosure. In this embodiment, for example, a fluid stream 110 containing a foulant is fed via an inlet to a liquid-gas separator, such as a Knockout (KO) drum 120 from an upstream refining process and/or refining equipment via a pipe, piping, or pipeline. As will be understood by those skilled in the art, the KO drum 120 separates gas from entrained and condensed liquids or liquid droplets. The KO drum 120 can be a two-phase separator, separating gas from liquid, or a three-phase separator, separating gas, water, and oil, for example. Those skilled in the art will understand that the KO drum also can be referred to as a flash drum, a knockout pot, a KO drum, a knock-out vessel, a flare KO drum, a mist eliminator, a scrubber separator, a vane pack separator, a demister pad separator, an inertial separator, a mesh pad separator, a droplet separator, a gas liquid separator, a vapor liquid separator, a cyclone separator, or a chevron mist eliminator.

Inside the Knockout drum 120, the fluid stream 110 is separated into a liquid and a gas, each of which is expelled to form a liquid stream (for example, output at a as a liquid outlet stream 160) and a gas stream. A filtering system within the Knockout drum 120 captures or entraps foulant as the fluid stream 110 flows through the filtering system. The filtering system may be positioned within the Knockout drum 120 to filter the gas, liquid, or a combination thereof. The filtering system removes foulant through one or more or more filtering devices, such as a filter (for example, a reticulated particle trap and/or other types of filters). After filtering, the fluid stream, in particular the separated gas stream (which, for example, may be free or substantially free from liquid or include less liquid than when the fluid stream entered the KO drum 120) exits the KO drum 120 as an outlet stream 130, where it continues downstream to a compressor 140. Further, separated liquid may exit the KO drum 120 as a second outlet stream 160.

As noted one or more filters positioned within the KO drum 120 may capture or entrap foulants from the fluid stream 110. The one or more filters may be reticulated and/or include pores that are sized in such a way to allow fluid to flow through the pores while simultaneously preventing foulant from passing through the pores. The pores may be sized to capture or entrap various types of foulants; for example, the pores may be larger in size to capture or entrap larger foulants, the pores may be smaller in size to capture or entrap smaller foulants, or a combination thereof. The pore sizing may additionally vary based on the type of fluid flowing through the pore, for example, a liquid or a gas. The distribution of pores, regardless of size, may be homogenous, heterogenous, or a combination thereof. A heterogenous distribution of pores may form a gradient within the KO drum 120, with the pores gradually increasing or decreasing in size. Gradients may be formed in the direction of the inlet to the outlet and/or from the outer edge of the filter to the middle of the filter. In another example, filters with differing pore sizes may be randomly distributed throughout the KO drum 120. The pore sizing and distribution, as well as the type of fluid to be filtered, may impact or influence the flow rate of the fluid stream, as will be understood by those skilled in the art. Further, each filter may be positioned within the KO drum 120 such that gaps of varying sizes are present between each of the filters. The gaps between each filter may allow for fluid to flow therethrough, preventing substantial impact on flow rate.

The filtering system may include one or more filters with pores distributed homogenously. For example, for a filtering system with more than one filter, each filter may have pores sized to capture or entrap the same type of foulant(s) and distributed in the same or similar manner. For homogenous pore distribution, a similar distribution is a homogenous distribution regardless of the pore size. For example, in a filtering system with one or more filters, the filter may have pores with a variety of sizes to capture or entrap a variety of foulants. In a filtering system with more than one filter, for example, each filter may have pores sized to capture or entrap the same or similar type of foulant(s) and distributed in the same or similar manner. In another example, for a filtering system with more than one filter, a first filter may have pores sized to capture a smaller foulant, and a second filter may have pores sized to capture a larger foulant.

The filtering system may include one or more filters with pores distributed heterogeneously. For example, for a filtering system with more than one filter, each filter may have pores sized to capture or entrap varying types of foulant(s) and distributed in a gradual or random manner. For heterogenous pore distribution, pores have a distinguishable distribution regardless of the pore size. Additionally, a distribution may be considered heterogenous if the pores were distributed as a gradient within the KO drum 120, with the pore sizes and/or the number of pores gradually increasing or decreasing, or randomly distributed throughout the KO drum 120. For example, for a filtering system with one or more filters, the filter may have pores sized to capture or entrap a variety of foulants but have a gradient or random distribution within the KO drum 120. In another example, for a filtering system with more than one filter, a first filter may have pores sized to capture or entrap a smaller foulant, a second filter may have pores sized to capture or entrap a larger foulant, and/or subsequent filters may be sized larger than previous filters. Both these filters would have a heterogenous distribution if the pore sizes and/or number of pores gradually increased or decreased, regardless of direction of the gradient.

These filtering systems have been found to remove a significant amount of foulant within a fluid, thus preventing the foulant from reaching a compressor. For example, a filtering system as presently disclosed may remove substantial amounts or substantially all of the targeted foulants from a fluid. “Substantial amounts” as used herein indicates at least 75%. “Substantially all” as used herein indicates at least 90%. In some embodiments, filters may be configured to capture or entrap substantial amounts or substantially all foulants of a given type or size. In other words, the filters may capture or entrap minimal amounts (less than 25%) of certain foulants, while capturing substantial amounts or substantially all of other foulants. Accordingly, foulant in a fluid may pass through one or more filters prior to being captured in the filtering system. Additionally, in some embodiments, some types of foulants are intentionally not filtered from fluid and, instead, are further processed and/or filtered downstream of the filtering system.

The filter disclosed herein, for example, may include or be comprised of one or more materials capable of withstanding the internal conditions of the Knockout drum, such as high temperature and/or high pressure conditions, in addition to exposure to potentially corrosive fluid and/or prolonged exposure to water or other non-corrosive fluids. For example, the filter may be ceramic-based material, plastic-based material, metal-based material, or a combination thereof. The material may be an inert material. In some embodiments, the filter used may include a CatTrap® or a TopTrap® filter product.

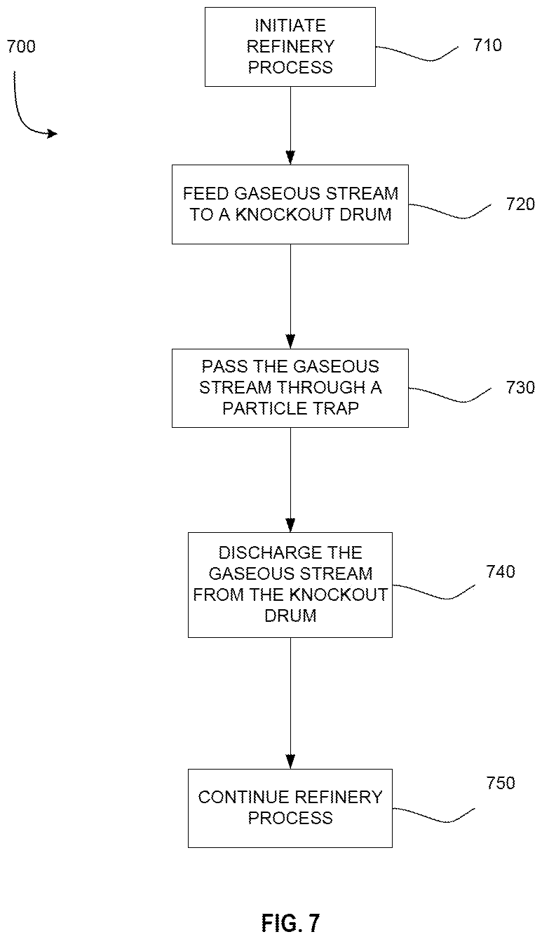

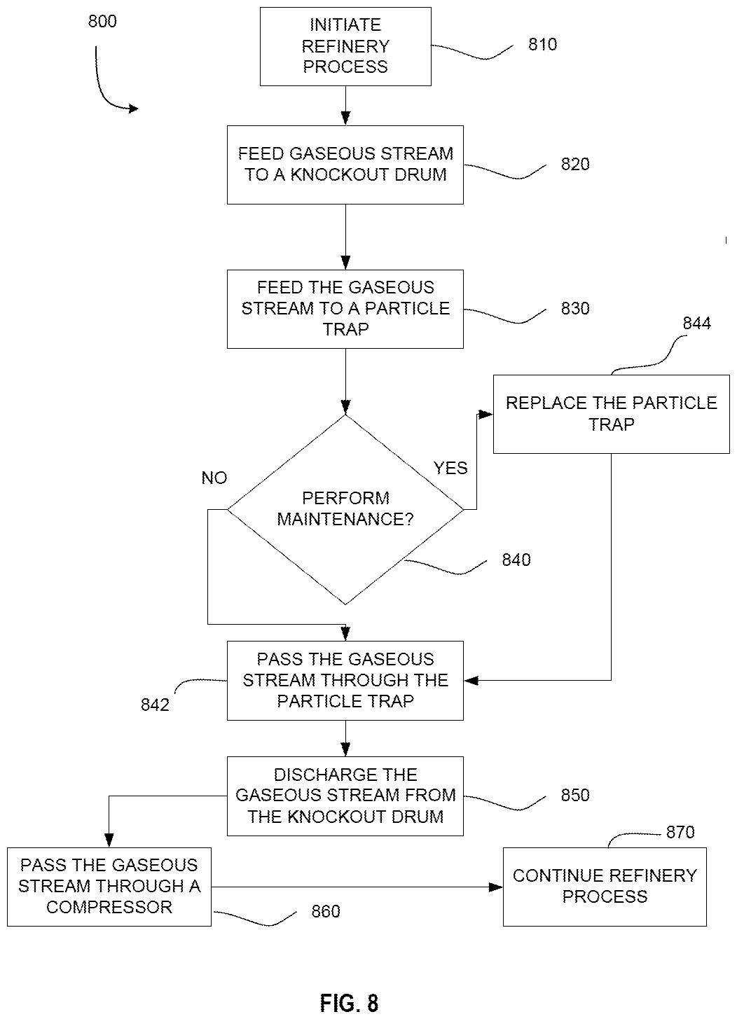

In an embodiment, the one or more filters may capture or entrap a selected amount of foulants. After the selected amount of foulants are captured, the one or more filters may be cleaned before the one or more filters are able to capture or entrap additional foulants. Further, as noted above, the one or more filters may affect the flow of fluid to a degree. Once a filter has captured the selected amount of foulants, flow through that filter may be impeded further. Thus, to ensure that flow of fluid through the KO drum 120 is not impeded, the one or more filters may be cleaned. To clean the one or more filters, a user may remove the filters and manually clean them (for example, by washing the filters with water and, in addition to water, in some embodiments, solvents and/or detergents). In another embodiment, a controller (as illustrated in FIGS. 7 and 8) may initiate a cleaning process. In such an embodiment, the controller may cause one or more valves to open and cause water (in addition to, in some embodiments, solvents and/or detergents) to be pumped to and through the KO drum 120, thus cleaning the one or more filters.

In another embodiment, the KO drum 120 may be partially filled with or completely filled with the filters. In an embodiment, a tray may be positioned within the KO drum 120. The tray may hold a selected amount of filters. The tray may be positioned such that gas and/or other fluid flows through the filters prior to exiting the KO drum 120.

FIG. 2 shows a simplified schematic diagram, according to an embodiment of the present disclosure. As illustrated, a system may include a first and second KO drums 220a, 220b, and a compressor 240. A fluid stream 210a may flow to the first KO drum 220a via a pipe, piping, or pipeline. In this embodiment, the first Knockout drum 220a may separate the fluid stream 210a into a liquid and a gas, each of which is expelled to form a gas stream and a liquid stream. The liquid stream may be expelled or transferred from the first KO drum 220a via a pipe, piping, or pipeline 260a. The gas stream may flow via pipeline 230a to the compressor 240 or to the second KO drum 220b. A filtering system, sub-system, device, or apparatus (hereinafter referred to as a sub-system) may be positioned within the KO drum 220a and/or the KO drum 220b, and may be configured to remove foulants from the fluid stream 210a. The filtering sub-system may remove foulants from the gas, liquid, or a combination thereof. Based on the configuration, the filtering sub-system may be positioned towards the top of the first KO drum 220a and/or second KO drum 220b, towards the bottom of the first KO drum 220a and/or second KO drum 220b, in the middle of the first KO drum 220a and/or second KO drum 220b, or a combination thereof. Further, the filtering sub-system may fill or partially fill the first KO drum 220a and/or second KO drum 220b. The filtering sub-system may also be positioned at the inlet of the first KO drum 220a, at the gas stream outlet (for example, proximate the connection between the first KO drum 220a and pipeline 230a), at the liquid stream outlet (for example, proximate the connection between the first KO drum 220a and pipeline 260a), at the inlet of the second KO drum 220b, at the gas stream outlet (for example, proximate the connection between the second KO drum 220b and pipeline 230b), at the liquid stream outlet (proximate the connection between the second KO drum 220b and pipeline 260b), or a combination thereof. A Knockout drum may include additional or alternative inlet and/or outlets, and the filtering sub-system may be positioned at any of these as well. The filtering sub-system may include one or more filters.

In an embodiment, the fluid stream 210a, as noted may flow to a KO drum (for example, the first KO drum 220a or the second KO drum 220b). In an embodiment, one of the first and second KO drums 220a and 220b may be active at a time, while the other may serve as a backup. In such embodiments, the fluid stream 210a and the gas output from the first KO drum 220a may bypass the second KO drum 220b. In such embodiments, during cleaning of the filtering sub-system in the first KO drum 220a, the second KO drum 220b may be active and the first KO drum 220a becomes the backup (for example, during and after cleaning). The outlet stream may then continue downstream in the refinery process to a compressor 240. In another embodiment, the fluid stream 210a may flow through both the first and second KO drum 220a and 220b in a sequential order. In such an embodiment, the first and second KO drum 220a and 220b may each contain the same or different filtering sub-system. For example, the first KO drum 220a may include a filtering sub-system with a larger pore size, while the second KO drum 220b may include a filtering sub-system with a smaller pore size.

FIG. 3 shows a simplified schematic diagram, according to another embodiment of the present disclosure. In this embodiment, for example, a KO drum 320a separates the fluid stream 310a into a gas and a liquid, each of which is expelled to form a gas stream. Within the KO drum 320a is a filtering system that is configured to remove foulants from the gas and the liquid. The filtering system includes one or more filters. The filtering system may remove foulants from the gas, liquid, or a combination thereof. Based on the configuration, the filtering system may be positioned towards the top of the KO drum, towards the bottom of the knockout drum, in the middle of the KO drum, or a combination thereof. The filtering system may also be positioned at the inlet of the KO drum 320a, at the gas stream outlet 330b, at the liquid stream outlet, or a combination thereof. A KO drum may include additional or alternative inlet and/or outlets, and a person of ordinary skill in the art will understand and recognize that a filtering system may be positioned at any of these as well. The filtering system may include one or more filters.

In this embodiment, the system has an additional or second KO drum 320b, which may have a filtering system configured the same as KO drum 320a. The presence of the second KO drum 320b allows the inlet stream to bypass KO drum 320a, and instead be processed by KO drum 320b. The additional KO drum 320b may allow the system 300 to continue when or if KO drum 320a is unable to process the inlet stream (e.g., maintenance). Once the inlet stream 310a is processed, it exits the KO drum to form an outlet stream 330b. In this embodiment, the outlet stream 330b may be further processed in KO drum 320c. KO drum 320c may have a filtering system as disclosed herein, although, in some embodiments, the KO drum 320c is configured to alter the outlet stream 330b in a different means or by a different means. For example, the KO drum 320c may be configured to further remove moisture from a the outlet stream 330b. In another embodiment, the KO drum 320c may include a filtering system as well and may further filter the outlet stream 330b, as well as remove moisture from the outlet stream 330b. The outlet stream 330c of KO drum 320c then continues downstream to a compressor 340.

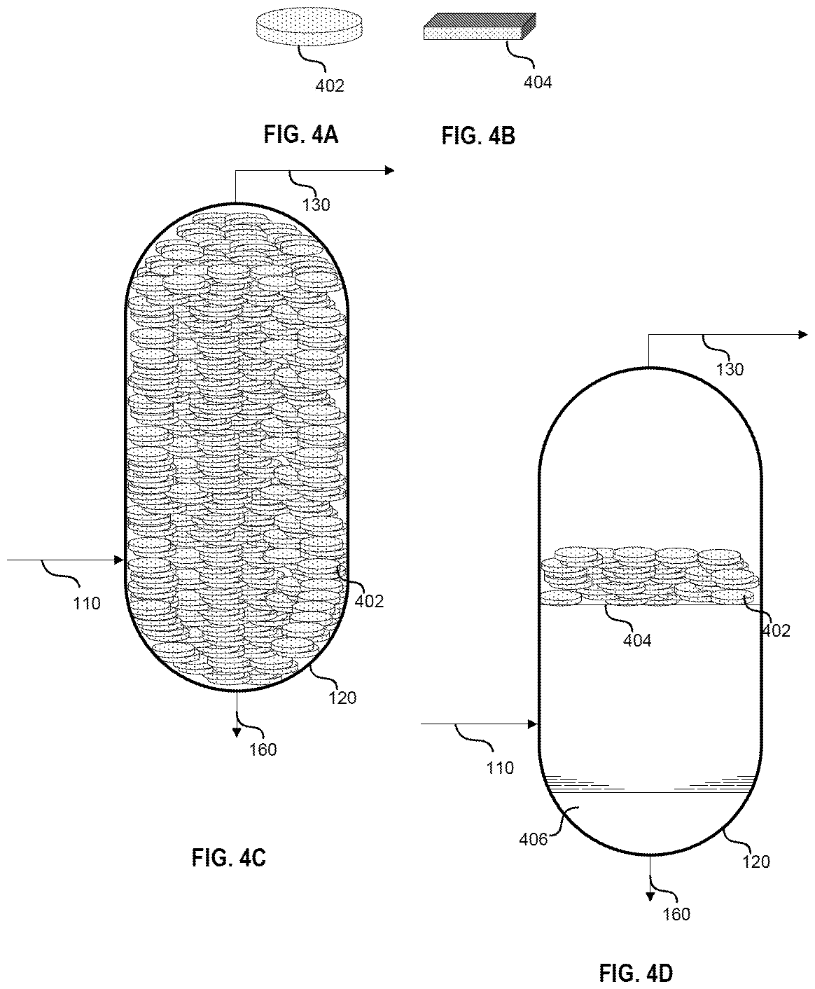

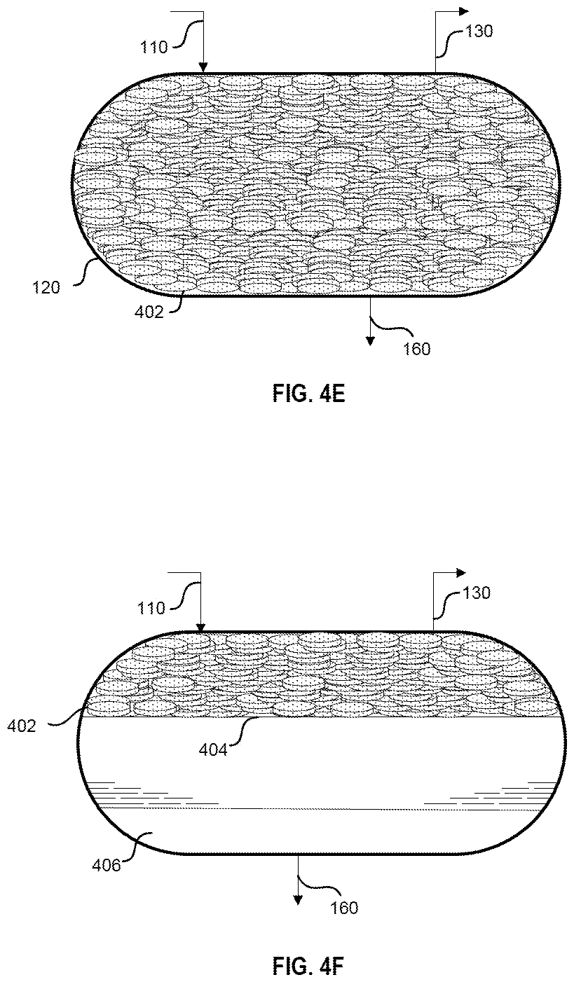

FIGS. 4A and 4B illustrate examples of reticulated particle traps. Particle trap 402 may comprise a disk or circular shape. The particle trap 402 may include pores of a selected size. In another embodiment, the pores may each be random sizes. In yet another embodiment, the particle trap 402 may be comprised of a ceramic material, a plastic material (for example, polyether, polyurethane, or other plastic material), a metal material, or other inert material. The diameter of the particle trap 402 may be about 0.5 inches to about 10 inches. The thickness of the particle trap 402 may be about 0.5 inches to about 1.5 inches. In another embodiment, the particle trap 404 may be shaped similar to a rectangle or square. As noted, the particle traps 402, 404 may capture, entrap, and/or attract foulants. As the particle traps 402, 404 capture, entrap, and/or attracts foulants, the particle traps 402, 404 may become saturated or unable to further capture, entrap, and/or attracts foulants. The particle traps 402, 404 may be washed with water (and, for example, in addition to water, detergents or solvents).

Turning to FIG. 4C, a KO drum 120 may include a filtering sub-system. In such examples, the filtering sub-system may include a plurality of particle traps 402 (and/or particle traps 404). For example, the KO drum 120 may be filled with the plurality of particle traps 402. As the KO drum 120 may include other components (for example, to remove entrained liquid 406 in a gaseous stream), the particle traps 402 may be positioned to fill in the remaining space within the KO drum 120. The KO drum 120 may, while retaining the ability to remove liquid from the gaseous stream, be able to filter foulants from the gaseous stream entering the KO drum 120. In another embodiment, as illustrated in FIG. 4D, the KO drum 120 may include a tray 404. In such embodiments, a portion of the KO drum 120 may be partially filled with particle traps 402, such as stacked on the tray 404. As shown in FIGS. 4C and 4D, the KO drum may be positioned vertically. In another embodiment, as illustrated in FIGS. 4E and 4F, the KO drum 120 may be horizontally positioned.

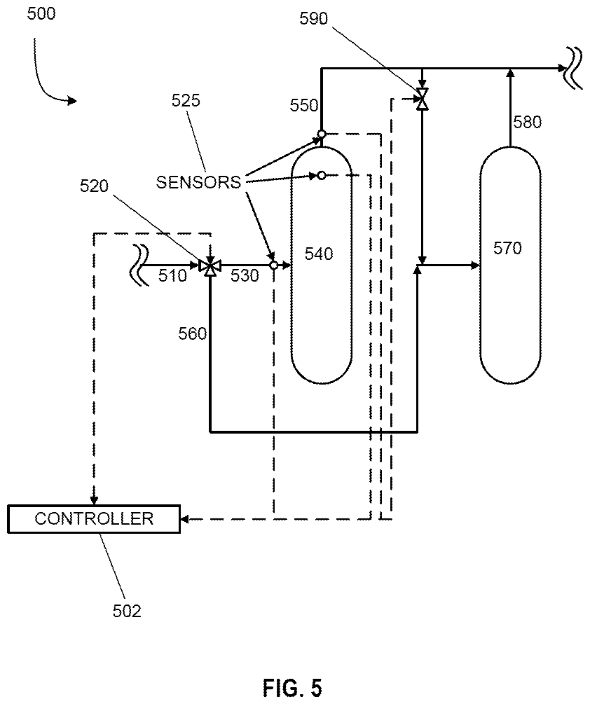

FIG. 5 illustrates a simplified schematic diagram, according to an embodiment of the present disclosure. In this embodiment, for example, a refinery process can continue despite foulant build up and/or a compressor may operate longer than typical, as foulant buildup may not occur or occur at a slower rate than typical (for example, due to the filtering of foulants). In such an embodiment, a refinery 500 may include one or more control systems disclosed herein and one or more KO drums 540, 570 with filtering systems, as described herein. For example, a controller 502 may be in communication or signal communication with one or more flow control devices 520, 590 and one or more sensors 525. The one or more sensors 525 may be positioned throughout the refinery 500 and configured to monitor the conditions of the one or more KO drums 540, 570 with a filtering system and/or of pipeline positioned proximate the KO drums 540, 570 and the fluid therein. The flow control devices 520, 590 may direct the fluid away from or to the one or more KO drums 540, 570 based on the conditions of the one or more KO drums 540, 570 and/or of pipeline positioned proximate the KO drums 540, 570.

In this embodiment, for example, a refinery 500 includes a first Knockout drum 540 with a first filtering system and a second Knockout drum 570 with a second filtering system. A fluid feed stream 510 enters a flow control device 560 that is in signal communication with the controller 502. The controller 502 directs the fluid feed stream 510 to define a first fluid input stream, for example. In this example, the first fluid input stream 530 enters the first Knockout drum 540, where the first fluid input stream 530 is separated into a residual liquid and a gas. Foulants from at least the gas are removed as the gas pass through the first filtering system. The residual liquid and gas are expelled from the first Knockout drum 540 as a first residual liquid stream and a first gas outlet stream. One or more sensors is positioned to monitor the conditions of the first Knockout drum 640, for example, a sensor 525 may be positioned at the inlet of the first Knockout drum 540, within the first Knockout drum 540, and/or at the outlet of the first Knockout drum 540. The sensor 525, for example, is configured to transmit data to the controller 502, such as flow rate or pressure of a fluid, for example. This data is indicative of the conditions within the refinery 500, for example, the first filtering system within the first Knockout drum 540. In a specific example, the data may show an increase in pressure at the inlet of the first Knockout drum 540, which may indicate that the first filtering system has filled with foulant and that the first Knockout drum 540 requires maintenance. If the data does not indicate that the first Knockout drum 540 requires maintenance, the first gas outlet stream 550 enters a flow control device 590 that defines a second gas outlet stream, for example, 580. The second gas outlet stream 580 continues downstream to a compressor. The compressor may filter the second gas output stream 580 to remove remaining foulants.

Alternatively, if the data does indicate that the first Knockout drum 540 requires maintenance, the controller 502 directs the flow control device 560 to re-route the fluid feed stream 560 and defines a second fluid input stream. The second fluid input stream enters a flow control device 590 that directs the second fluid input stream to define a third fluid input stream, for example. The third fluid input stream enters the second Knockout drum 570, where the third fluid input stream is separated into a residual liquid and a gas. Foulants from at least the gas are removed as the gas pass through the second filtering system. The residual liquid and gas are expelled from the second Knockout drum 570 as a second residual liquid stream and a third gas outlet stream. One or more sensors 525 is positioned to monitor the conditions of the second Knockout drum 570, for example, a sensor may be positioned at the inlet of the second Knockout drum 570, within the second Knockout drum 570, and/or at the outlet of the second Knockout drum 570. The sensor 670, for example, is configured to transmit data to the controller, such as flow rate or pressure of a fluid, for example. This data is indicative of the conditions within the refinery 500, such as the first filtering system within the first Knockout drum 540. In a specific example, the data may indicate or show an increase in pressure at the inlet of the second Knockout drum 570, which may indicate that the second filtering system has filled with foulant and that the first Knockout drum 540 requires maintenance. If the data does not indicate that the second Knockout drum 570 requires maintenance, the third gas outlet stream continues downstream to a compressor. The compressor may filter the third gas outlet stream to remove remaining foulants.

After the controller 502 redirects the fluid flow stream from the first Knockout drum 540 to the second Knockout drum 570, maintenance can be performed on the first Knockout drum 540 without pausing the refinery process. The controller 502 may also direct a filter control device to correct the maintenance issue. In some embodiments, the correction may be a notification or alarm indicating a filtering system issue, for a person working in the refinery to fix. In some embodiments, the correction may be to fix the issue with the filtering system itself. For example, the controller may identify that the filtering system has, or likely has, a clogged filter. The controller may then direct the filter control device to replace the filter with another filter, clean the filter, or perform the needed maintenance.

After maintenance is completed, the controller may redirect the fluid flow stream 510 from the second Knockout drum 570 to the first Knockout drum 540 if the data from the one or more sensors 525 indicates that the second Knockout drum 570 requires maintenance.

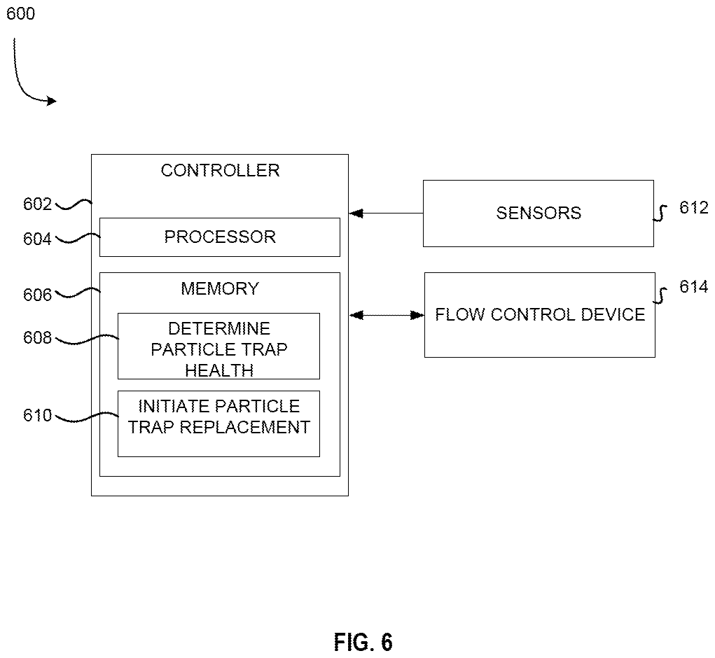

FIG. 6 illustrates a control system for managing a filtering system. The controller 602 may include a machine-readable storage medium, or memory 606, and one or more processors 604. As used herein, a “machine-readable storage medium” may be any electronic, magnetic, optical, or other physical storage apparatus to contain or store information such as executable instructions, data, and the like, as will be understood by those skilled in the art. For example, any machine-readable storage medium described herein may be any of random access memory (RAM), volatile memory, non-volatile memory, flash memory, a storage drive (e.g., hard drive), a solid state drive, any type of storage disc, and the like, or a combination thereof. The memory 606 may store or include instructions executable by the processor 604. As used herein, a “processor” may include, for example one processor or multiple processors included in a single device or distributed across multiple computing devices. The processor 604 may be one or more of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution instructions stored on a machine-readable storage medium, or a combination thereof, as will be understood by those skilled in the art.

As used herein, “signal communication” refers to electric communication such as hard wiring two components together or wireless communication, as understood by those skilled in the art. For example, wireless communication may be Wi-Fi®, Bluetooth®, ZigBee, or forms of near field communications. In addition, signal communication may include one or more intermediate controllers or relays disposed between elements that are in signal communication with one another.

In an embodiment, the controller 602 include instructions 608 to determine a particle trap health. Upon execution of instructions 608, the controller 602 may obtain the conditions at various points and/or locations or of materials in the refinery system. Sensors 612 or probes may provide, in real-time and/or continuously or at regular intervals, a signal to the controller 602 indicative of the conditions within the Knockout drum and/or indicative of the condition of the materials within or exiting the Knockout drum.

Other sensors 612 may be disposed throughout the system 600 to measure or indicate various other aspects or characteristic within the system, as will be understood by those skilled in the art. For example, the sensors positioned and/or disposed throughout the system 600 may be pressure transducers, flow meters, mass flow meters, Coriolis meters, other measurement sensors to determine a density, flow, temperature, or other variable as will be understood by those skilled in the art, or some combination thereof. As noted above, the controller 602 may be in signal communication with the sensors 612. The controller 602 may poll or request data from the sensors 612 at various points or substantially continuously during the refinery process.

The system 600 may include one or more different flow control devices 614. The flow control devices 614 may include a gaseous stream flow control device, a liquid flow control device, and/or other flow control devices to control an amount of material or fluid flowing from one location to another. Each flow control device 614 may include one or more of a pump, a meter (as described herein), a sensor or probe (as described herein), a valve (e.g., a control valve, a slide valve, or another valve configured to control an amount of fluid or material flowing therethrough), and/or some combination thereof. In such examples, each component of the flow control device 614 may be in signal communication with the controller 602. The flow control devices 614 may allow for adjustment of the flow of the fluid or material based on various factors received by the controller 602. In an embodiment, the flow control devices 614 may redirect a fluid stream from one KO drum to another (for example, based on KO drum maintenance schedules or events and/or based on a determination by the controller 602 that the KO drum maintenance may occur).

The system 600 may include one or more different filter control devices, as understood by those skilled in the art. For example, the system 600 may include filtering systems to filter fluid flowing through the refinery process. The filtering systems (or, in particular, a sensor, flow control device, or subcontroller of the filtering system) may be in signal communication with the controller 602. The controller 602 may in signal communication with a filter control device 614. In such examples, the filter control device 614 may allow for replacement and control of filters within the filtering system.

The controller 602 may receive and send information, data, and/or instructions to and from, respectively, the various sensors or probes 612, flow control devices 614, and/or filter control devices. In such examples, the controller 602 may receive some characteristic regarding one or more different parts of the system 600 including the sensors or probes (e.g., temperature and/or pressure within a Knockout drum) and, based on those characteristics and one or more preselected thresholds (e.g., a preselected temperature range and/or pressure range within the Knockout drum), adjust flow and/or amount of one or more materials or fluids flowing into or supplied to the Knockout drum. When characteristics indicate that a filter need maintenance, the controller 502 may fix or replace the filter.

In an embodiment, the memory 606 may include instructions 610 to determine and/or initiate replacement and/or cleaning of a particle trap positioned in the KO drum. Instructions 610, when executed, may obtain data related to one or more particle traps, the location of the particle traps, and/or based on other factors. In such embodiments, the instructions 610, when executed, may cause the controller 602 to obtain data from one or more sensors positioned on, in, and/or proximate one or more KO drums. Once the controller 602 has obtained the data, the controller 602 may initiate cleaning or replacement of particle trap positioned within one of the KO drums. For example, if the pressure within a KO drum is higher than typical, then the controller 602 may indicate or may initiate a cleaning process. The controller 602 may also consider flow rate from a KO drum, temperature within or proximate the KO drum, and/or time since a previous cleaning or replacement. Initiation of a cleaning process may include transmitting a prompt to a user and/or pumping water through the KO drum until the particle traps are clean.

FIG. 7 illustrates an flow diagram of a method of an embodiment of the present disclosure. At block 710, the method begins with initiating a refinery process, such as refining one or more hydrocarbons. The refinery process may include compressing one or more gasses. As such, to perform such a compression step, at block 720, a gaseous stream including foulants may be fed to a KO drum. The KO drum may include a plurality of reticulated particle traps (or other types of filters). Further, the KO drum may separate liquids from the gaseous stream, as the gaseous stream passes through the KO drum. At block 730, as the gaseous stream passes through the KO drum, the gaseous stream may flow through and around the plurality of reticulated particle traps. As the gaseous stream flows through the plurality of reticulated particle traps, each of the reticulated particle traps may capture or entrap foulants within the gaseous streams (in other words, the reticulated particle traps may filter the gaseous stream). At block 740, the filtered gas stream is then expelled from the Knockout drum and, at block 750, continues along the refinery process (for example, to a compressor for compression).

FIG. 8 is a flow diagram, implemented in a controller, for managing a filtering of a fluid stream prior to a compressor, according to an embodiment of the disclosure. The method 800 is detailed with reference to the controller 602 of FIG. 6. Unless otherwise specified, the actions of method 800 may be completed within the controller 602. Specifically, method 800 may be included in one or more programs, protocols, or instructions loaded into the memory of the controller 602 and executed on the processor or one or more processors of the controller 602. The order in which the operations are described is not intended to be construed as a limitation, and any number of the described blocks may be combined in any order and/or in parallel to implement the methods.

At block 810, the controller 602 may initiate a refinery process, such as refining one or more hydrocarbons. The refinery process may include, as part of a sub-process, compressing one or more gasses. As such, to perform such a compression step, at block 820, a gaseous stream, including foulants, may be fed to a KO drum. The KO drum may include a plurality of reticulated particle traps (or other types of filters). Further, the KO drum may separate liquids from the gaseous stream, as the gaseous stream passes through the KO drum. At block 830, as the gaseous stream passes through the KO drum, the gaseous stream may flow through and around the plurality of reticulated particle traps. As the gaseous stream flows through the plurality of reticulated particle traps, each of the reticulated particle traps may capture or entrap foulants within the gaseous streams (in other words, the reticulated particle traps may filter the gaseous stream).

As foulants are captured, over time the reticulated particle trap may become saturated or unable to capture or entrap additional foulants. The controller 602, at block 840, may determine whether the reticulated particle traps are to be maintained (for example, cleaned or replaced). The controller 602 may determine that the reticulated particle traps are to be maintained based on one or more of flow rate from the KO drum (as determined by the controller 602 based on data from one or more sensors or flow meters positioned proximate a KO drum), pressure within the KO drum (as determined by the controller 602 based on data from one or more sensors or pressure transducers positioned proximate and/or within a KO drum), temperature of a fluid stream and/or within the KO drum (as determined by the controller 602 based on data from one or more sensors positioned proximate and/or within a KO drum), and/or based on a time since the last cleaning and/or replacement of the reticulated particle trap, among other factors. In another embodiment, the controller 302 may determine whether to perform maintenance by monitoring the pressure of the fluid expelled from the KO drum and comparing that pressure to a selected threshold or selected pressure threshold.

If the controller 602 determines that the reticulated particle trap is to be cleaned or replaced, the controller, at block 844, may initiate such a cleaning or replacement. In an embodiment, the controller 602 may prompt a user to perform such management. In another embodiment, the controller 602 may direct water, as well as, in some embodiments, solvents and/or detergents, to the KO drum via one or more pipelines. The water (and, in some embodiments, the solvents and/or detergents) may flow through the KO drum, thus cleaning the reticulated particle traps.

At block 842, if the controller 602 determines that the reticulated particle trap is not to be cleaned or if the reticulated particle trap has been cleaned, then the controller 602 may direct, via one or more flow control devices, the gaseous stream through the KO drum and, thus, through the reticulated particle trap. At block 850, the filtered gas stream is then expelled from the Knockout drum and, at block 860, passed through a compressor for compression. At block 870, the controller 602 may continue the refinery process. Thus, the method 800 may enable a reduced compressor maintenance time, as less or no foulants may reach the compressor.

Specific compositions, methods, or systems are intended to be only illustrative of the embodiments disclosed by this specification. Variation on these systems, methods, or embodiments are readily apparent to a person of skill in the art based upon the teachings of this specification and are therefore intended to be included as part of the inventions disclosed herein.

This application claims priority to and the benefit of U.S. Provisional Application No. 63/470,739, filed Jun. 2, 2023, titled “METHODS AND SYSTEMS FOR REDUCING CONTAMINANTS IN A FEED STREAM,” the disclosure of which is incorporated herein.

The above detailed description is given for explanatory or illustrative purposes. It will be apparent to those skilled in the art that numerous changes and modifications can be made without departing from the scope of the inventive aspects of the technology. Accordingly, the whole of the foregoing description is to be construed in an illustrative and not a limitative sense, the scope of the invention being defined solely by the appended claims.

1. A method for reducing contaminants in hydrocarbon based fluid stream in a transportation fuel refinery, the method comprising:
feeding a hydrocarbon based fluid stream into one or more Knockout drums positioned in a transportation fuel refinery, the hydrocarbon based fluid stream to include foulant;
separating the hydrocarbon based fluid stream into a gas and a liquid in the one or more Knockout drums;
passing the gas through one or more filters positioned within the one or more Knockout drums to entrap foulant in the one or more filters when the gas passes therethrough; and
expelling the gas from the one or more Knockout drums to a compressor for compression.

2. The method of claim 1, further comprising:
monitoring a pressure of the gas expelled from the one or more Knockout drums;
comparing the pressure of the gas expelled from the one or more Knockout drums to a selected threshold; and
in response to the pressure exceeding the selected threshold, directing the hydrocarbon based fluid stream to bypass the one or more Knockout drums.

3. The method of claim 1, wherein the compressor includes one or more additional filters positioned upstream from the compressor, and further comprising separating foulant from the gas expelled from the one or more Knockout drums by use of the one or more additional filters prior to passing the gas stream into and through the one or more compressors.

4. The method of claim 1, further comprising passing the liquid through the one or more filters to entrap foulant in the one or more filters when the liquid passes therethrough.

5. The method of claim 1, wherein the one or more filters (a) partially fill the Knockout drum or (b) substantially completely fills the Knockout drum.

6. The method of claim 1, wherein the one or more filters includes a plurality of pores distributed along the one or more filters as a gradient.

7. The method of claim 1, wherein the one or more filters comprise a plurality of reticulated particle traps positioned within the one or more Knockout drums, and wherein the each of the plurality of reticulated particle traps include a selected pore size.

8. The method of claim 7, wherein the one or more Knockout drums include one of (a) a plurality of reticulated particle traps with a similarly selected pore size or (b) a plurality of reticulated particle traps with a randomly selected pore size.

9. A method for reducing contaminants in a hydrocarbon based gas stream in a transportation fuel refinery to extend a compressor's maintenance time, the method comprising:
directing a hydrocarbon based gas stream to flow into a first Knockout drum, the first Knockout drum being a two-phase separator;
separating at least a portion of entrained liquid from gas in the hydrocarbon based gas stream;
passing the gas through a plurality of pores of one or more reticulated particle traps to entrap at least a portion of solid foulant as the gas passes therethrough;
expelling the gas from the first Knockout drum to form a filtered hydrocarbon based gas stream;
directing the filtered hydrocarbon based gas stream to a compressor for compression, the filtered hydrocarbon based gas stream to include reduced contaminants to extend the compressor's maintenance time;
monitoring a pressure of the gas expelled from the first Knockout drum; and
while the pressure of the gas expelled from the first Knockout drum falls within a selected threshold, maintaining a second Knockout drum as a backup to the first Knockout drum.

10. The method of claim 9, further comprising: when the pressure of the gas expelled from the first Knockout drum exceeds the selected threshold,
re-directing the hydrocarbon based gas stream to flow into the second Knockout drum instead of the first Knockout drum;
separating at least a portion of entrained liquid from gas in the hydrocarbon based gas stream;
passing the gas through a plurality of pores of one or more reticulated particle traps to entrap solid foulant as the gas passes therethrough;
expelling the gas from the second Knockout drum to form a filtered hydrocarbon based gas stream;
directing the filtered hydrocarbon based gas stream to the compressor for compression, the filtered hydrocarbon based gas stream to include reduced contaminants to extend the compressor's maintenance time; and
cleaning or replacing the one or more reticulated particle traps positioned within the first Knockout drum.

11. The method of claim 10, further comprising:
monitoring a pressure of the gas expelled from the second Knockout drum; and
while the pressure of the gas expelled from the second Knockout drum falls within a selected threshold, maintaining the first Knockout drum as a backup to the second Knockout drum.

12. The method of claim 11, wherein the cleaning of the one or more reticulated particle traps
comprises, pumping water through the plurality of pores of the one or more reticulated particle traps in the first Knockout drum.

13. The method of claim 9, wherein a third Knockout drum is positioned downstream of the first Knockout drum and upstream of the compressor, and prior to directing the filtered hydrocarbon based gas stream to the compressor, the method further comprises separating residual liquid from the filtered hydrocarbon based gas stream by use of the third Knockout drum.

14. The method of claim 10, wherein the one or more reticulated particle traps in the second Knockout drum are one of (a) the same as the one or more reticulated particle traps in the first Knockout drum or (b) different than the one or more reticulated particle traps in the first Knockout drum.

15. The method of claim 13, wherein the third Knockout drum includes one or more reticulated particle traps.

16. The method of claim 9, wherein the plurality of pores of the one or more reticulated particle traps of the first Knockout drum are distributed as a gradient.

17. The method of claim 9, wherein the one or more reticulated particle traps are configured to entrain solid foulant of varying sizes.

18. The method of claim 9, wherein the compressor includes one or more filters, and the method further comprises separating residual solid foulant from the filtered hydrocarbon gas stream by use of the one or more filters.

19. A foulant reducing system to reduce foulants in a fluid feed stream prior to compression via a compressor to extend a maintenance time of the compressor, the system comprising:
a first pipeline;
a second pipeline;
a first Knockout drum connected to the first pipeline and the second pipeline, and including a plurality of filters, and configured to (a) receive the fluid feed stream from the first pipeline, (b) remove liquid from the fluid feed stream to form a gas stream output via the second pipeline and a liquid stream, and (c) capture foulants via the plurality of filters;
a third pipeline connected to the second pipeline;
a second Knockout drum connected to the first pipeline and the third pipeline, and configured to operate as a backup Knockout drum while the first Knockout drum continues to operate as a primary Knockout drum; and
a compressor connected to the second pipeline and the third pipeline to receive a gas stream from one or more of the first Knockout drum and the second Knockout drum, with access to the first Knockout drum and the second Knockout drum, the compressor including a third filtering system.

20. The system of claim 19, wherein the first Knockout drum and the second Knockout drum are configured to separate the fluid feed stream into a liquid and a gas.

21. The system of claim 19, wherein the second Knockout drum includes a second plurality of filters configured to capture foulants when the second Knockout drum operates as a primary Knockout drum.

22. The system of claim 20, wherein the first Knockout drum and the second Knockout drum further include:
one or more inlets accessible to the fluid feed stream via connection to the first pipeline; and
one or more outlets configured to expel gas so as to define a gas outlet stream via connection to the second pipeline and the third pipeline.

23. The system of claim 22, the system further comprising a monitoring system that includes:
one or more sensors configured to monitor a pressure of the gas outlet stream and to transmit the pressure as data; and
a controller configured to receive data from the one or more sensors.

24. The system of claim 23, wherein the controller is in communication with a flow control device, the flow control device configured to direct the fluid feed stream to the second Knockout drum if a differential between a pressure of the gas outlet stream of the first Knockout drum and a set pressure limit reaches or exceeds a set differential limit.

25. The system of claim 23, wherein the controller is in communication with a flow control device, the flow control device configured to direct the fluid feed stream to the first Knockout drum if ta differential between a pressure of the gas outlet stream of the second Knockout drum and a set pressure limit reaches or exceeds a set differential limit.

26. A controller for to reduce foulants in a fluid feed stream prior to compression via a compressor to extend a maintenance time of the compressor, the controller comprising:
a first input in signal communication with a first pressure sensor, the first pressure sensor positioned within, on, or proximate a first Knockout drum and configured to measure pressure within the first Knockout drum, the first Knockout drum including one or more filters and configured to remove liquid from a fluid stream and foulants from the fluid feed stream;
a first input/output in signal communication with a flow control device, the flow control device positioned along a pipeline and configured to redirect flow of the fluid stream; and
the controller configured to:
monitor the pressure within the first Knockout drum, and
while the pressure within the first Knockout drum is below a selected threshold:
maintain a second Knockout drum as a backup, and
maintain a position of the flow control device that causes the fluid stream to be directed to the first Knockout drum.

27. The controller of claim 26, wherein the controller is further configured to:
if the pressure within the first Knockout drum is above the selected threshold:
adjust the flow control device to cause the fluid stream to be directed to the second Knockout drum.

28. The controller of claim 27, wherein the controller is further configured to:
while the fluid stream is directed to the second Knockout drum, maintain the first Knockout drum as the backup.

29. The controller of claim 28, wherein the controller is further configured to:
while the first Knockout drum is the backup, clean the one or more filters included in the first Knockout drum.

30. The controller of claim 26, wherein flow control device includes one or more of a control valve, a pump, or other devices.
